(19) United States
(12) Patent Application Publication
(10) Pub. No.: US 2023/0281541 A1
(43) Pub. Date: Sep. 7, 2023

(54) SYSTEMS AND METHODS FOR GENERATING INSIGHTS BASED ON REGULATORY REPORTING AND ANALYSIS

(71) Applicant: Fidelity Information Services, LLC, Jacksonville, FL (US)

(72) Inventors: Benjamin Wellmann, Delray Beach, FL (US); Harry M. Stahl, New York, NY (US); David Berglund, Ponte Vedra, FL (US); Gary Michael Duma, Royal Oak, MI (US); John J. Cicinelli, Auburn, NH (US); Ravi Dangeti, Wickford (GB)

(73) Assignee: Fidelity Information Services, LLC, Jacksonville, FL (US)

(21) Appl. No.: 18/178,132

(22) Filed: Mar. 3, 2023

Related U.S. Application Data
(60) Provisional application No. 63/268,829, filed on Mar. 3, 2022.

(51) Int. Cl. G06Q 10/0635; G06Q 40/12

(52) U.S. Cl. CPC G06Q 10/0635; G06Q 40/12

(57) ABSTRACT

Systems, devices, methods, and computer readable media for providing regulatory insight analysis are disclosed. In one implementation, the disclosed system may receive input data from a plurality of sources. Consistent with disclosed embodiments, the system may normalize the received input data. Further, the system may analyze the normalized input data, the analyzing comprising using logic for generating an output based on a first input including the normalized input data, a second input including calculation attributes, and a third input including one or more rules. The system may further be configured to store the output, continuously monitor the output as the output is stored, and generate one or more reports based on the stored output. Further, the system may receive, from a user and via a user interface, additional input data, a request to view the one or more generated reports, or a request for an additional output.

### CROSS-REFERENCE TO RELATED APPLICATION

This application claims priority to U.S. Provisional Patent Application No. 63/268,829, filed on Mar. 3, 2022, the entire contents of which are incorporated herein by reference.

### FIELD OF THE DISCLOSURE

The disclosed embodiments generally relate to systems, devices, methods, and computer-readable medium for performing and providing regulatory insight analysis.

### BACKGROUND

Regulatory reporting demands data precision as well as consistent monitoring to determine accurate risk ratios, maintain error-free data across multiple systems, and deliver accurate reports. Extant solutions for regulatory insight analysis and reporting include a multi-step mechanical process which requires extraction of raw data from internal accounting, trading, and risk systems (which may range, e.g., from two systems to several dozen systems), checking for consistency against data standards, consolidating the data into a shared data space, normalizing the combined data, and running summary calculations where necessary to meet reporting requirements. After generation and submission of the reports, regulators then review these reports to identify any risk and compliance issues.

As a result, there exists a need for technical reporting based on the continuous evolution of regulations which may enable users to proactively and efficiently review the effects of consistently updating regulatory data received from a variety of sources. Such technical regulatory insight solutions may include, e.g., systems and methods which proactively and efficiently surface data irregularities and provide reporting based on an analysis of new regulatory requirements, including, e.g., providing benchmarks and forecasting based on new or upcoming regulations. Such technical regulatory insight solutions may also include providing updated algorithms as regulatory conditions change in order to help users receive relevant reporting and in order to provide reports and predictions which help ensure that their organizations remain in compliance. Without such improved technical solutions, businesses may fail to make necessary changes in order to keep up with ever-changing regulatory requirements. The present disclosure addresses such needs and further provides additional technical improvements and tools in light of the continuously changing regulatory landscape.

### SUMMARY

Embodiments of the present disclosure may include a system for providing regulatory insight analysis, including a memory. Embodiments may also include at least one data storage medium. Embodiments may also include at least one processor configured to receive input data from a plurality of sources. In some embodiments, the at least one processor may also be configured to normalize the received input data.

In some embodiments, the at least one processor may also be configured to analyze the normalized input data, the analyzing including using logic for generating an output based on a first input including the normalized input data, a second input including calculation attributes, and a third input including one or more rules. In some embodiments, the at least one processor may also be configured to store the output.

In some embodiments, the at least one processor may also be configured to continuously monitor the output as the output may be stored. In some embodiments, the at least one processor may also be configured to generate one or more reports based on the stored output. In some embodiments, the at least one processor may also be configured to receive, from a user and via a user interface, additional input data, a request to view the one or more generated reports, or a request for an additional output.

In some embodiments, the at least one processor may be further configured to store the normalized input data in a transient data storage prior to analyzing the normalized input data. In some embodiments, the at least one processor may be further configured to generate the calculation attributes based on the normalized input data from at least one of the plurality of sources. In some embodiments, the at least one processor may also be configured to store the calculation attributes.

In some embodiments, the at least one processor may be further configured to receive the one or more rules as configured by the user via the user interface. In some embodiments, the at least one processor may also be configured to store the one or more rules. In some embodiments, the at least one processor may be further configured to leverage the stored output to build at least one of a data mart or a data lake.

In some embodiments, the at least one processor may be further configured to monitor a value received based on the continuously monitored output. In some embodiments, the at least one processor may also be configured to determine a threshold value based on the one or more rules. In some embodiments, the at least one processor may also be configured to trigger a restful endpoint upon receiving a monitored value meeting or exceeding the determined threshold value. In some embodiments, triggering the restful endpoint may provide at least one additional function based on the received monitored value.

In some embodiments, the at least one processor may be further configured to securely distribute the stored output to multiple client-side devices. In some embodiments, the at least one processor may be further configured to provide, via the user interface, insights based on the stored output using at least one of a model or a pipeline generated via a machine learning platform.

Embodiments of the present disclosure may also include a method for providing regulatory insight analysis, the method including receiving input data from a plurality of sources. Embodiments may also include normalizing the received input data. Embodiments may also include analyzing the normalized input data, the analyzing including using logic for generating an output based on a first input including the normalized input data, a second input including calculation attributes, and a third input including one or more rules.

Embodiments may also include storing the output. Embodiments may also include continuously monitoring the output as the output is stored. Embodiments may also include generating one or more reports based on the stored output. Embodiments may also include receiving, from a user and via a user interface, additional input data, a request to view the one or more generated reports, or a request for an additional output.

In some embodiments, the method may include storing the normalized input data in a transient data storage prior to analyzing the normalized input data. In some embodiments, the method may include generating the calculation attributes based on the normalized input data from at least one of the plurality of sources. Embodiments may also include storing the calculation attributes.

In some embodiments, the method may include receiving the one or more rules as configured by the user via the user interface. Embodiments may also include storing the one or more rules. In some embodiments, the method may include leveraging the stored output to build at least one of a data mart or a data lake.

In some embodiments, the method may include monitoring a value received based on the continuously monitored output. Embodiments may also include determining a threshold value based on the one or more rules. Embodiments may also include triggering a restful endpoint upon receiving a monitored value meeting or exceeding the determined threshold value. In some embodiments, triggering the restful endpoint may provide at least one additional function based on the received monitored value.

In some embodiments, the method may include securely distributing the stored output to multiple client-side devices. In some embodiments, the method may include providing, via the user interface, insights based on the stored output using at least one of a model or a pipeline generated via a machine learning platform.

Embodiments of the present disclosure may also include a non-transitory computer readable medium containing instructions that when executed by at least one processor, cause the at least one processor to perform operations for providing regulatory insight analysis, the operations including receiving input data from a plurality of sources. Embodiments may also include operations for normalizing the received input data.

Embodiments may also include operations for analyzing the normalized input data, the analyzing including using logic for generating an output based on a first input including the normalized input data, a second input including calculation attributes, and a third input including one or more rules. Embodiments may also include operations for storing the output.

Embodiments may also include operations for continuously monitoring the output as the output may be stored. Embodiments may also include operations for generating one or more reports based on the stored output. Embodiments may also include operations for receiving, from a user and via a user interface, additional input data, a request to view the one or more generated reports, or a request for an additional output.

In some embodiments, the operations may further include providing, via the user interface, insights based on the stored output using at least one of a model or a pipeline, the at least one of a model or a pipeline being generated via a machine learning platform. In some embodiments, the operations may further include storing the normalized input data in a transient data storage prior to analyzing the normalized input data.

In some embodiments, the operations may further include monitoring a value received based on the continuously monitored output. Embodiments may also include operations for determining a threshold value based on the one or more rules. Embodiments may also include operations for triggering a restful endpoint upon receiving a monitored value meeting or exceeding the determined threshold value. In some embodiments, triggering the restful endpoint may provide at least one additional function based on the received monitored value.

### BRIEF DESCRIPTION OF THE DRAWINGS

FIG. 1 is a diagram of an exemplary regulatory reporting environment, consistent with disclosed embodiments.

FIG. 2 is a diagram of an exemplary regulatory reporting environment, consistent with disclosed embodiments.

FIG. 3 is a detailed diagram of an exemplary regulatory reporting environment including individual components of a system for regulatory insights analysis, consistent with disclosed embodiments.

FIG. 4 is a flow chart showing an exemplary method for performing data transformation, learning, and configuration, consistent with disclosed embodiments.

FIG. 5 is a flow chart showing an exemplary method for performing data normalization during data intake, consistent with disclosed embodiments.

FIG. 6 shows an exemplary artificial intelligence (AI) classification, as applied to a balance sheet, consistent with disclosed embodiments.

FIG. 7 is a block diagram showing an exemplary platform architecture for implementing a system for regulatory insights analysis, consistent with disclosed embodiments.

FIG. 8 is a block diagram showing an exemplary operating environment for providing systems and methods for regulatory insights analysis, consistent with disclosed embodiments.

FIG. 9 is a block diagram showing an exemplary system for providing regulatory insights analysis, consistent with disclosed embodiments.

FIG. 10 is a block diagram showing a first detailed portion of an exemplary insights platform for providing regulatory insights analysis, consistent with disclosed embodiments.

FIG. 11 is a block diagram showing a second detailed portion of an exemplary insights platform for providing regulatory insights analysis, consistent with disclosed embodiments.

FIG. 12 is a flow chart showing an exemplary method for performing regulatory insights analysis, consistent with disclosed embodiments.

### DETAILED DESCRIPTION

It is to be understood that both the foregoing general description and the following detailed description are exemplary and explanatory only and are not restrictive of this disclosure. The accompanying drawings, which are incorporated in and constitute a part of this specification, illustrate several exemplary embodiments and together with the description, serve to outline principles of the exemplary embodiments.

This disclosure may be described in the general context of customized hardware capable of executing customized preloaded instructions such as, e.g., computer-executable instructions for performing program modules. Generally, program modules include routines, programs, objects, components, data structures, and so forth, which perform particular tasks or implement particular abstract data types. The disclosed embodiments may also be practiced in distributed computing environments where tasks are performed by remote processing devices that are linked through a communications network. In a distributed computing environment, program modules may be located in local and/or remote computer storage media including memory storage devices.

The present disclosure describes systems, methods, and computer-readable media that enables users to proactively and efficiently review regulatory data and regulatory reporting, thereby maintaining consistent compliance with local regulations which may be continuously updated. Using the systems, methods, and computer-readable media disclosed herein, organizations may quickly receive analysis information including a forward-looking view of regulatory risk, tools with which to investigate anomalies, and automated compliance reporting.

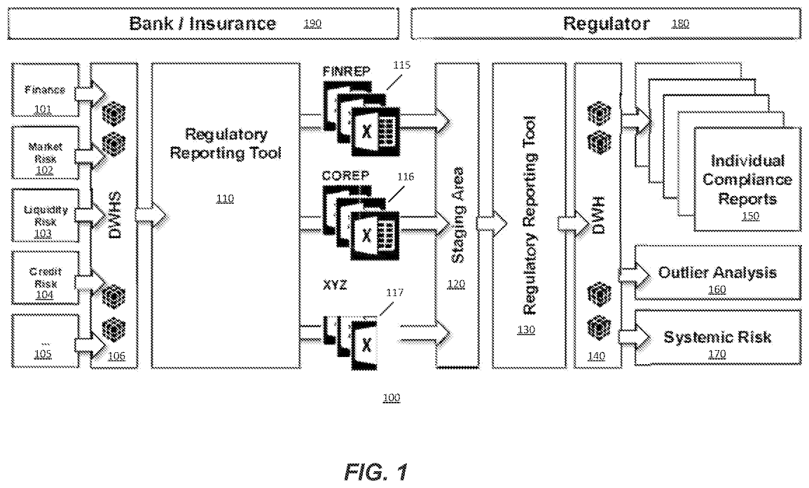

FIG. 1 is a diagram of an exemplary regulatory reporting environment 100, consistent with disclosed embodiments. As shown in FIG. 1, several data sources (e.g., a finance data source 101, a market risk data source 102, a liquidity risk data source 103, a credit risk data source 104, and other data sources 105) may provide data which is stored in a first data warehouse 106. The first data warehouse 106 may supply data to a first regulatory reporting tool 110, which may be configured to generate a plurality of reports (e.g., Financial Reporting 115, Common Reporting 116, and other reporting 117, as shown in FIG. 1). In some embodiments, the data sources 101-105, the first data warehouse 106, the first regulatory reporting tool 110, and the report generation 115-117 may be performed on computer systems on the side of a bank or an insurance company 190.

As further shown in FIG. 1, the plurality of reports 115-117 may then be sent to a staging area 120 within computer systems on the side of a regulator 180. The staging area 120 may be accessed by a second regulatory reporting tool 130. The second regulatory reporting tool 130 may be configured to process the plurality of reports 115-117 and store the processed reports in a second data warehouse 140. The second data warehouse 140 may include tools configured to produce a plurality of end reports, including, e.g., individual compliance reports 150, an outlier analysis report 160, and a systemic risk report 170.

Because this report generation (on the bank and insurance company side) is a periodic effort, not a continuous activity, this becomes an extra burden endured by, e.g., controllers, CROs, CFOs, and data analysts—e.g., from a dozen employees spending approximately 200 hours in a smaller bank to more than a hundred employees spending approximately 2,000 hours in larger, more complex institutions. While the industry remains focused on the creation and submission of compliance reports on a quarterly basis, the systems, methods, and computer-readable media of the present disclosure enable users to manage risk and detect inconsistent data more proactively and more efficiently, e.g., on a daily basis.

As compliance requirements further evolve, banks and insurers are faced with the additional challenge of continuously adjusting their reporting systems, which are separate from the reporting systems of regulating institutions. The systems, methods, and computer-readable media of the present disclosure instead enable a combination of the previously separate reporting systems of companies and regulating institutions into a single regulatory insight platform. The resulting single regulatory insight platform not only helps streamline the exchange of regulatory data and reporting but also removes the need for updating individual reporting systems for coherence between one another as they are adjusted based on regulatory evolution.

In addition, banks and insurers, as well as regulators, are also faced with the task of understanding core risk and compliance issues based on a received combination of continuously updating regulatory data. The systems, methods, and computer-readable media of the present disclosure further enable predictive forecasting and business intelligence insights through artificial intelligence and machine learning tools. As a result, both businesses and regulators further benefit from the systems, methods, and computer-readable media of the present disclosure by gaining forward-looking knowledge to better understand core risk and compliance issues based on a predictive and/or probabilistic analysis of large amounts of collected data.

The systems, methods, and computer-readable media of the present disclosure may implement a data processing model that normalizes and structures diverse data inputs. For example, balance sheet position and reporting attributes, static data, and market data may be consolidated into a single platform for providing regulatory risk insights and data surveillance. The systems, methods, and computer-readable media of the present disclosure enable customers to proactively and efficiently surface data irregularities, thereby providing a novel regulatory insight analysis and reporting platform which includes output data such as cross-industry benchmarks and forecasting.

The systems, methods, and computer-readable media of the present disclosure may enable users, including, e.g., executives at banks and insurers, to precisely monitor regulatory conditions and data irregularities instantaneously. The systems, methods, and computer-readable media of the present disclosure may further provide automation and machine learning tools to eliminate manual steps and human error. The systems, methods, and computer-readable media of the present disclosure may apply artificial intelligence (AI) to normalize and resolve data quality issues. The systems, methods, and computer-readable media of the present disclosure may also be compatible as a plug-in with existing systems, such as finance data marts or data platforms, to capture structured and unstructured data from accounting, risk, trading, and other internal and external systems. The captured data may then be transformed to enable functions such as performing various calculations. The captured data and the calculated results may then be securely stored. The calculation and analysis results may be presented in a clear and flexible analysis tool via one or more user interfaces. In some embodiments, the systems, methods, and computer-readable media of the present disclosure may be implemented as a software-as-a-service (SaaS) platform.

As users review generated reports and identify compliance or data anomalies, they may further track the data lineage to investigate or repair issues. The systems, methods, and computer-readable media of the present disclosure may provide a supervisory capability to identify any regulatory risk issues proactively and efficiently, preventing the need for thousands of investigative hours and various reactive measures to achieve the same compliance.

The systems, methods, and computer-readable media of the present disclosure may include an artificial intelligence (AI) engine that can normalize the data on the fly. The AI engine may also permit banks (for example) to see how new regulations may impact them even before the regulations are made official (i.e., by performing various “what if” scenario analyses).

The solutions disclosed herein may further address regulatory challenges faced by banks and insurers by leveraging AI to harmonize data across multiple sources to empower, e.g., regulatory executives and analysts at banks and insurers to enjoy on-demand surveillance and regulatory insight analysis to help users remain in compliance.

The systems, methods, and computer-readable media of the present disclosure empower customers to proactively and efficiently surface data irregularities and review insights, including cross-industry benchmarks and forecasting. The systems, methods, and computer-readable media of the present disclosure may further be configured to constantly update regulatory algorithms as conditions change and the machine learning solution transforms the data to help users receive relevant reporting and ensure their organizations remain in compliance.

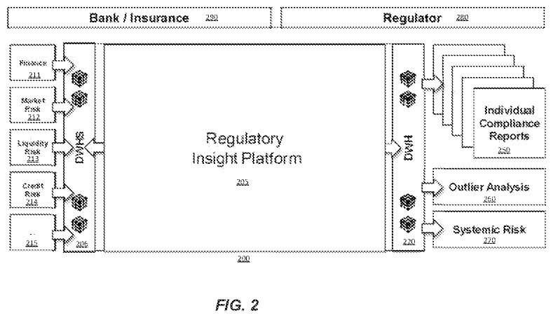

FIG. 2 is a diagram of an exemplary regulatory reporting environment 200 that uses the systems, methods, and computer-readable media of the present disclosure, consistent with disclosed embodiments. As shown in FIG. 2, the regulatory insight platform 205 exists between a first data warehouse 206 and a second data warehouse 220. In some embodiments, the regulatory insight platform 205 may be configured to perform the functions of the first regulatory reporting tool 110, the staging area 120, and the second regulatory reporting tool 130 shown in FIG. 1. The regulatory insight platform 205 may further include machine learning and artificial intelligence components configured to process input data received from various different sources and in various different formats, and to generate additional reports to be accessed by regulators and/or users without requiring human intervention. As used herein, the term “component” may include a hardware component configured to perform a specific function that may be performed by a processor (such as a central processing unit (CPU), a graphics processing unit (GPU), an application specific integrated circuit (ASIC), or a field programmable gate array (FPGA)) or an integrated circuit; a software component configured to perform a specific function; or a combination of hardware and software.

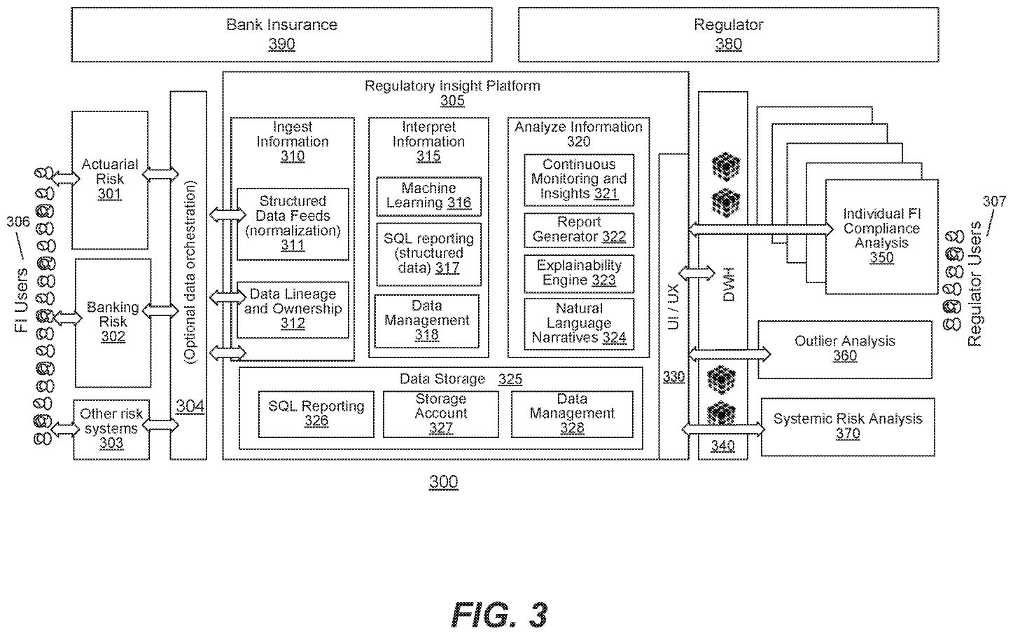

FIG. 3 is a detail diagram of an exemplary regulatory reporting environment 300 that uses an exemplary regulatory insight platform 305, including individual components thereof, consistent with disclosed embodiments. As shown in FIG. 3, a data orchestration component may be used in the first data warehouse 304 to coordinate the data transfer from the data sources 301-303 into a regulatory insight platform 305. The regulatory insight platform 305 may include an ingest information component 310, a data lineage and ownership component 312, an interpret information component 315, an analyze information component 320, and a data storage component 325.

The ingest information component 310 may include a structured data feeds component 311 configured to perform data normalization such that the data may be more easily processed by the regulatory insight platform 305. The data lineage and ownership component 312 may be configured to provide information about the data (e.g., metadata) including information such as, for example, whether a data item is a calculated field or is raw data. The interpret information component 315 may include a machine learning component 316, a Structured Query Language (SQL) reporting component 317 configured to process structured data, and a data management component 318.

The analyze information component 320 may include a continuous monitoring and insights component 321, a report generator component 322, an explainability engine 323, and a natural language narratives component 324. The continuous monitoring and insights component 321 may be configured to continuously collect data and analyze the collected data, for example, in real-time, to identify trends, patterns, and potential problems. This may be performed through the use of, e.g., automated monitoring systems or automated data collection processes. The continuous monitoring and insights component 321 may further be configured to collect knowledge from analysis of collected data. In some embodiments, the analysis may be performed in near real-time. In turn, such knowledge may be used, e.g., to identify opportunities for improvement, to optimize processes, or to make informed decisions, any of which leads to improved performance and decision-making. The report generator component 322 may be configured to automatically generate standardized reports in a consistent and efficient manner based on specified data and parameters. For example, the report generator component 322 may process data to produce a finished report such as, e.g., a written document, a spreadsheet, a presentation, or another type of output format. As another example, the report generator component 322 may be configured to offer features such as data visualization tools, an ability to generate reports in various languages, and an ability to schedule automatic report generation. The explainability engine component 323 may be configured to provide an understanding of how a machine learning model makes decisions, which may include, e.g., composition of data and intelligent drill-down capabilities. For example, the explainability engine component 323 may identify the most important features that contributed to a particular machine learning model decision while also identifying any biases or inconsistencies in the model's decision-making process, thereby improving the trust and accountability of machine learning systems.

The natural language narratives component 324 may be configured to generate descriptions or other narrative output in human-like text or speech using natural language processing and machine learning algorithms. The natural language narratives component 324 may be configured to utilize a range of natural language processing techniques which incorporate custom machine learning algorithms and models. For example, the natural language narratives component 324 may process documents or portions of documents (e.g., line items of a document) and classify them to a broader taxonomy or category. As another example, the natural language narratives component 324 may utilize transfer-learning techniques on large, pre-trained models (e.g., BERT, GPT) which are tuned based on particular data systems. As yet another example, the natural language narratives component 324 may generate summaries in coherent text (e.g., plain language), explaining key drivers or factors that underly a given output metric, based on data output by, e.g., the continuous monitoring and insights component 321. Any known or open source natural language processing algorithms or models may be utilized to perform the steps described herein to create novel and custom machine learning models trained based on specific client data. The natural language narratives component 324 thereby complements and extends the business value that the regulatory insight platform 305 provides in a number of ways. It empowers users to generate written reports at the click of a button and document new observations in charts in written language. This provides an increased efficiency in data analysis and reporting teams due to the reduced manual and repetitive efforts in writing-up observations. Overall, this leads to better-informed decision making that achieves success across the entire organization via the regulatory insight platform 305.

The data storage component 325 may include an SQL reporting component 326, a storage account component 327, and a data management component 328. The SQL reporting component 326 may be configured to generate reports using Structured Query Language (SQL). For example, the SQL reporting component 326 may extract data from a database via one or more executed queries and format the extracted data to present it in a structured manner, e.g., in the form of a table or chart. The structured output data may be utilized to provide insights, track performance, and/or make informed business decisions. The storage account component 327 may be configured to provide various types of storage options including file storage, block storage, and object storage, each type having its own unique characteristics. For example, the storage account component 327 may store large amounts of data to be accessible at any time, e.g., to be used as a data backup, data archives, or other data which needs to be accessed quickly. The storage account component 327 may further be scalable and flexible, allowing the platform/users to increase or decrease storage capacity needs. The data management component 328 may be configured to organize, store, and maintain the data that is collected by the platform. For example, the data management component 328 may create and maintain databases, setup and enforce data governance policies, or ensure proper data backup and security. As another example, the data management component 328 may ensure that stored data in accurate, consistent, and up to date, and that the data is utilized effectively and efficiently.

The regulatory insight platform 305 may also include a user interface (Up/user experience (UX) component 330 configured to interface with the second data warehouse 340, through which employees of the regulator 307 and/or users from an organization 306 may access reports 350, 360, 370 generated by the regulatory insight platform 305.

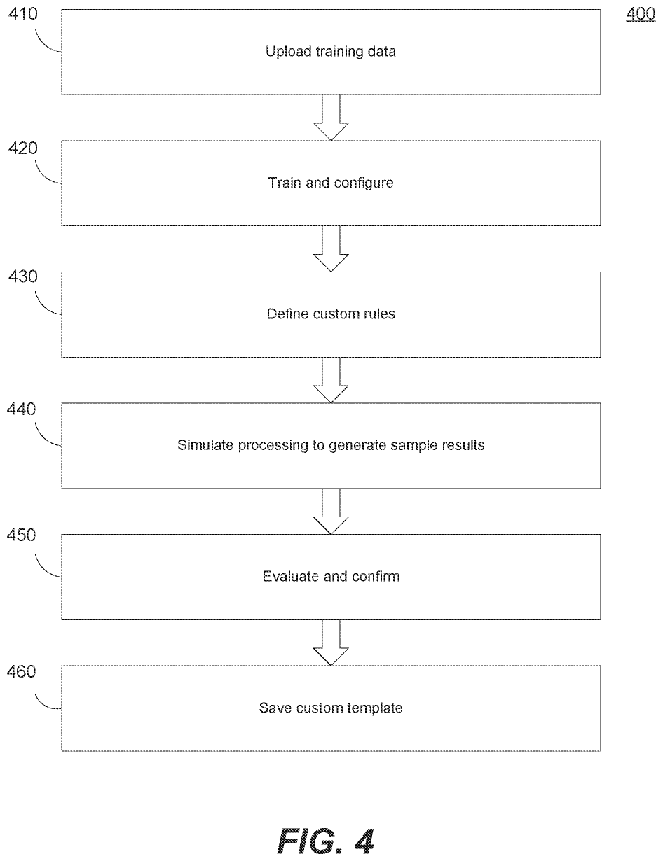

FIG. 4 is a flow chart of an exemplary method 400 for performing data transformation, learning, and configuration, consistent with disclosed embodiments. Transformation, as used herein, refers to the process of converting data from one format to another in order to make it more useful or accessible. Transformation, e.g., may involve changing the structure of the data, adding or removing fields, or converting data from one type to another. Learning, as used herein, refers to the process of training a machine learning model on a set of data in order to make predictions or classify new data. Learning, e.g., may involve providing a machine learning model with a large dataset and adjusting the model's parameters and algorithms based on the data to improve its performance. Configuration, as used herein, refers to the process of setting up and configuring a machine learning model or system in order to optimize its performance and functionality. Configuration, e.g., may involve selecting and fine-tuning specific algorithms, choosing appropriate input data and parameters, and testing the machine learning model to ensure that it is working correctly.

In some embodiments, method 400 may include a first step 410 where training data may be uploaded into the system by, e.g., a user. As an example, training data may include a dataset of transactions, a collection of records and results, a set of templates labelled with respective formats, and/or a collection of text data with respective categories. Method 400 may further include a step 420 for training and configuring the system based on the uploaded training data. For example, the system may use tools such as natural language processing (NLP) to aid in generating mappings of data into classifications as part of the training and configuring step 420. For instance, the system may use part-of-speech tagging to identify grammatical roles of words, named entity recognition to identify specific entities in a text, sentiment analysis to determine an overall sentiment of a portion of text, text classification to determine a particular category associated with the text, text summarization to generate shorter versions of text, or text generation to create new text based on a given input.

Further, method 400 may include a step 430 of the system defining custom rules based on the training and configuring. Custom rules may be defined by the system by, e.g., identifying patterns or relationships within analyzed training data sets, and based on the patterns or relationships, the system may generate custom rules or decision boundaries to be used for making predictions or classifying new data. As another example, custom rules may be defined by the system to support filtering and advanced aggregation. Method 400 may also include a step 440 of simulating processing by the system to generate sample results. For example, performance may be simulated by the system using template processing to generate sample results. The system may, e.g., simulate processing to generate sample results by using algorithms and statistical models to analyze and make predictions based on an input dataset. Method 400 may further include a step 450 of the system evaluating and confirming the sample results, and a step 460 of the system saving the custom template upon confirmation (or re-processing upon failure of confirmation). For example, the sample results may be evaluated and confirmed by the system before a custom template is saved and put into operation. Confirmation of sample results may be performed by, e.g., cross-validation, holdout validation, bootstrapping, ensemble methods, visualization, or other evaluation metrics. As another example, the system may continually adjust its algorithms and models based on the accuracy of its predictions, allowing it to improve over time and become more accurate in its predictions.

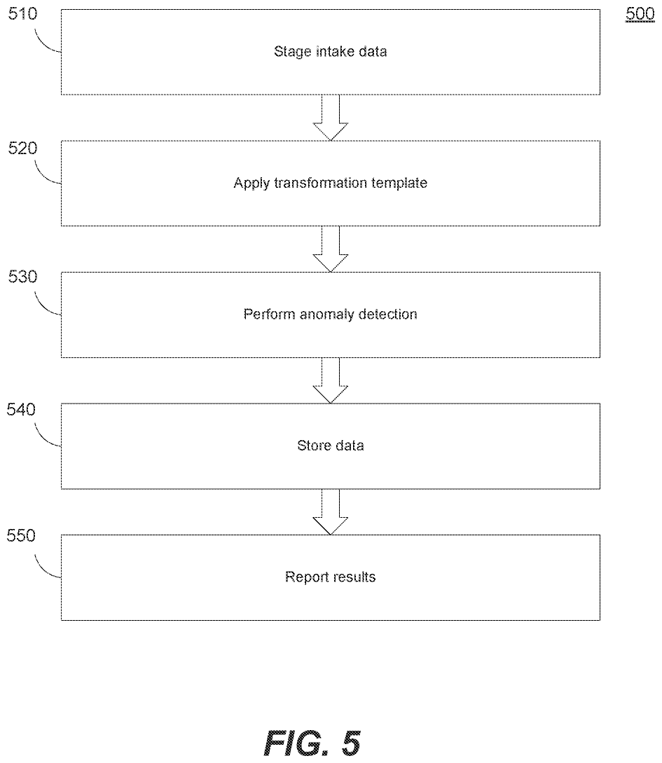

FIG. 5 is a flow chart of an exemplary method 500 for performing data normalization during data intake, consistent with disclosed embodiments. Data normalization, as used herein, refers to the standardization, scaling, and/or centering of data so that it conforms to a standard range or distribution, or such that bias or outlier data may be removed. Data normalization may be performed, e.g., to ensure that data from different sources or measurements can be compared and analyzed effectively. Data normalization may be an automated processing supporting well-defined representational state transfer (REST) services or multi-part file uploads. Method 500 may include a step 510, where the intake data may be staged, and a step 520 where a transformation template may be applied to the data, wherein the structure of the transformation template may be defined, e.g., by REST principles. To stage data may mean to temporarily store data in a specific location before it is processed or analyzed further. Staging data, as used herein, may allow for a more organized and controlled approach to handling and manipulating large amounts of data, as it allows for data cleansing, quality checking, and formatting before it is moved to its final destination.

Method 500 may further include a step 530, where anomaly detection may be performed based on, e.g., transformation rules and historical data trends. Anomalies may be detected, e.g., by identifying data points that are significantly different from the rest of the data set, or by detecting unusual patterns or trends. For example, if the data is normally distributed, data points that are much higher or lower than the mean may be considered anomalies. Similarly, if the data is following a specific pattern, data points that do not fit that pattern may be considered anomalies. As another example, if the data is normally distributed, a sudden shift in the distribution may be considered an anomaly. Similarly, if the data is following a specific pattern, a sudden deviation from that pattern may be considered an anomaly.

Method 500 may also include a step 540 where the data may be stored in a normalized database or data store if, e.g., a confidence standard is met. Further, method 500 may include a step 550 where stored results are reported to a user or entity. As an example, the reported results may include potential data anomalies and/or a data confidence level.

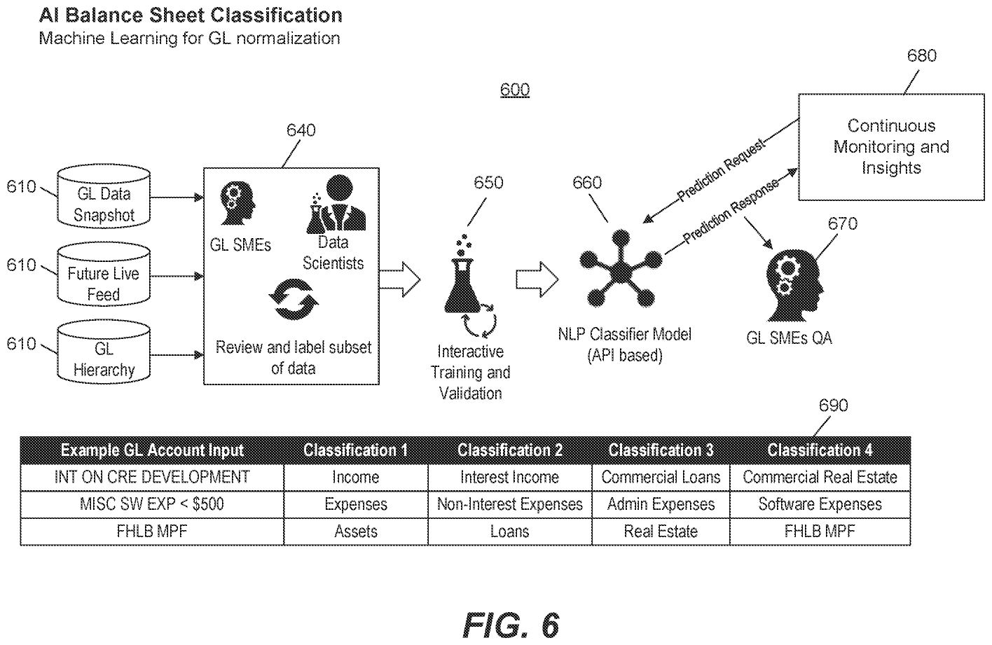

FIG. 6 shows an exemplary system 600 for artificial intelligence-based (AI-based) classification, as applied to a balance sheet, consistent with disclosed embodiments. AI-based classification, as used herein, refers to a machine learning technique that involves training a model to assign data points to one or more predefined categories or classes. An exemplary goal of the AI-based classification may be to normalize the data provided in a balance sheet using natural language processing techniques, as described herein. Raw general ledger entries, which may be cryptic and/granular in nature, may be processed and classified into broader and more meaningful categories, as shown in FIG. 6 (see, e.g., table 690 showing classifications 1 through 4 based on input including values in a general ledger account). Such classifications enable both transparency of data and explainability of key drivers and factors related to risk, loss, and/or revenue for, e.g., reporting purposes. The model may be trained using a labeled dataset, where each data point is associated with a specific class. During training, the model may learn to recognize patterns and features that are indicative of a particular class. After training, the model may be used to predict the class of new and/or unseen data points. Any one or more of several types of AI-based classification algorithms may be used, including decision trees, k-nearest neighbors, support vector machines, and neural networks. Each of the types of algorithms differ in the way they process and analyze the data, but they all aim to find a boundary or decision surface that separates the different classes in the training data.

As shown in the example of FIG. 6, data from various sources (e.g., a general ledger (GL) data snapshot 610, a future live feed 620, and a GL hierarchy 630) may be reviewed and labeled by a group 640 of GL subject matter experts (SMEs) and/or data scientists, thereby creating training data to be uploaded to a machine learning module. The reviewed and labeled data may then be used by the module for iterative training and validation 650 to generate and build, using the machine learning module, an application programming interface-based (API-based) natural language processing (NLP) classifier model 660. The NLP classifier model 660 may then receive prediction requests from a continuous condition monitoring application 680, and the model 660 may provide prediction responses to the monitoring application 680 in response to the received prediction requests. GL SMEs 670 may further perform quality analysis (QA) on the prediction responses provided by the NLP classifier model 660 in order to further confirm the accuracy of the model 660.

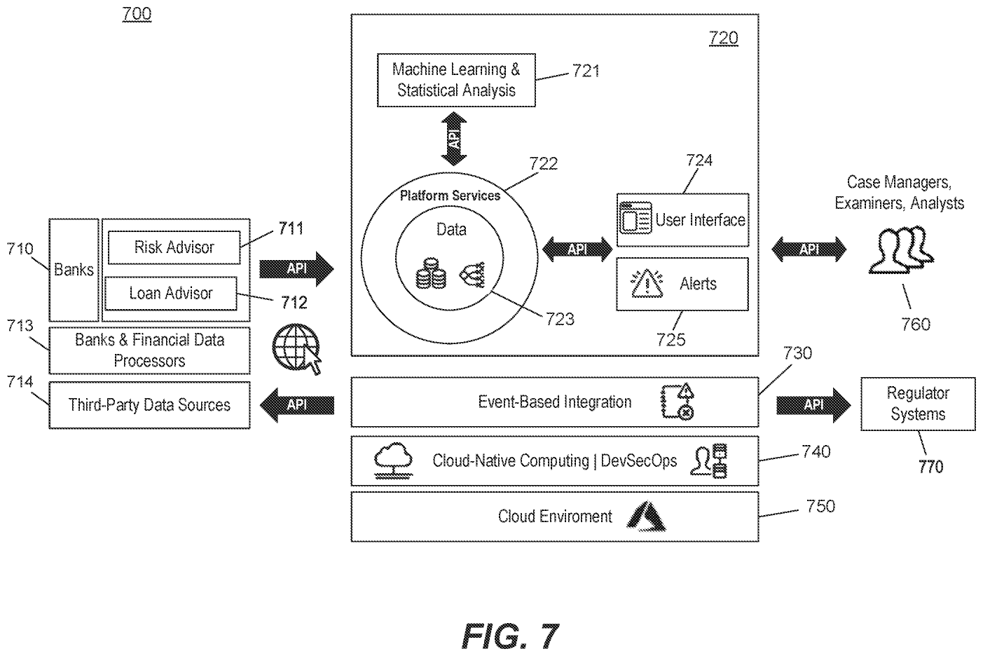

FIG. 7 is a block diagram showing an exemplary platform architecture 700 for implementing a system for regulatory insights analysis, consistent with disclosed embodiments. A regulatory insight platform 720 is shown in the middle portion of FIG. 7 and may be accessed by a bank side (providing data inputs) and a regulator side (receiving reports and data from the bank side). The bank side may include a risk advisor component 711, a loan advisor component 712, a financial data processor component 713, and third-party data sources 714. A risk advisor component 711 may provide input data including an assessment of risks that the bank may or will face, as determined, e.g., based on financial statement analysis, business practice analysis, and operations analysis, to the regulatory insight platform 720. A loan advisor component 712 may provide input data including an assessment of loans that the bank provides to the regulatory insight platform 720. The assessment may be based on, e.g., an analysis of lending procedures, guidelines, and documentation maintained by the bank as a lender. A financial data processor component 713 may provide input data including an assessment of the bank's management of financial data to the regulatory insight platform 720. The assessment may be based on, e.g., an analysis of recorded transactions, account balances, customer information, and other financial record information, as well as the accuracy, security, and authenticity of such data. Third-party data sources 714 may also provide input data to the regulatory insight platform 720. Third-party data sources 714 may include, e.g., credit reporting agencies, marketing companies, or other financial institutions.

The bank side may communicate with the regulatory insight platform 720 through one or more application programming interfaces (APIs). The regulatory insight platform may include a platform services component 723 including data a storage component 722, a machine learning and statistical analysis component 721, a user interface component 724, and an alerts component 725. A platform services component 723 may refer to the ingest information component, data lineage and ownership component, interpret information component, and analyze information component of a regulatory insight platform, as described herein. A machine learning and statistical analysis component 721 may refer to an artificial intelligence and machine learning platform, as described herein. A user interface component 724 may refer to a user interface, as described herein. An alerts component 725 may refer to a report generator component, as described herein, and more specifically, to a particular portion of a report generator component which generates alerts based on, e.g., a threshold value.

The regulatory insight platform 720 may further run on top of an event-based integration component 730, a cloud-native computing component 740 (which may include development, security, and operations (DevSecOps) tools), and a cloud environment component 750. An event-based integration component 730 may enable the various components of platform 720 to communicate with each other by exchanging messages or events. Events may be triggered by certain actions or conditions, e.g., the completion of a task, the arrival of new data, or the occurrence of an error. The event-based integration component 730 enables more scalability, flexibility, and reliability than traditional integration approaches, as it allows systems or applications of the platform 720 to communicate asynchronously, without the need for direct connections or dependencies between them. As a result, the platform 720 includes a more dynamic and responsive integration environment, where different components can communicate and collaborate in real-time, to support a wide range of integrated processes and functions.

A cloud-native computing component 740 enables high availability and resiliency, as well as built-in fault tolerance and the ability to automatically recover from failures. The cloud-native computing component 740 may further ensure that the platform 720 runs on cloud-native applications which make use of distributed systems and microservices architectures, allowing the platform 720 and its various components to be more scalable and adaptable to changing workloads. The cloud-native computing component 740 may further include DevSecOps tools including, e.g., NESSUS, ANSIBLE, QUALYS, SPLUNK, JENKINS, TARRAFORM, and TRIPWIRE.

A cloud environment component 750, as used herein, refers to the infrastructure and technologies that support the delivery of cloud computing services. The cloud environment component 750 may include, e.g., data centers, servers, storage systems, networking equipment, and virtualization technologies that enable the delivery of cloud services such as computing, storage, and networking, thereby causing the platform 720 to operate and perform its functions.

It will be understood that the event-based integration component 730, the cloud-native computing component 740, and the cloud environment 750 may include any combination of suitable components not limited to those described above, and it will further be understood that the regulatory insight platform 720 may operate in a similar manner regardless of the underlying technologies supporting it.

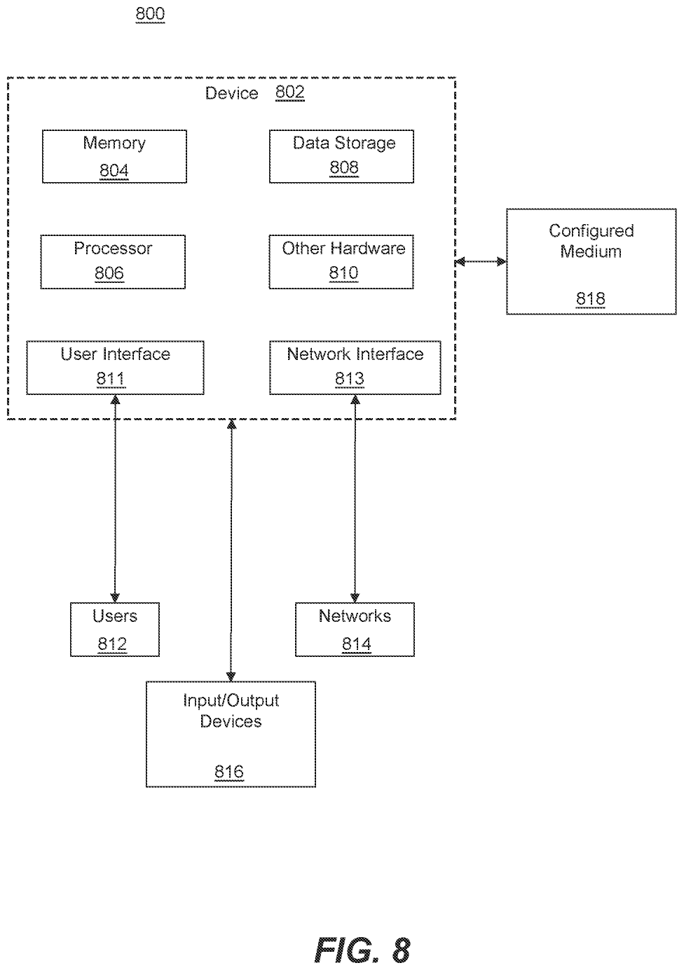

FIG. 8 is a block diagram showing an exemplary computing device for providing systems or methods for regulatory insights analysis, consistent with disclosed embodiments. As illustrated in FIG. 8, an exemplary system may include a general-purpose computing device 802 in the form of a computer. Components of the general-purpose computing device 802 may include, but are not limited to, various hardware components, such as one or more processors 806, data storage 808, a system memory 804, other hardware 810, and a system bus that couples various system components such that the components may transmit data to and from one another. The system bus may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

With further reference to FIG. 8, an operating environment 800 for an exemplary embodiment includes at least one computing device 802. The computing device 802 may be a multiprocessor computing device. An operating environment 800 may include one or more computing devices in a given computer system, which may be clustered, client-server networked, and/or peer-to-peer networked within a cloud. An individual machine is a computer system, and a group of cooperating machines is also a computer system. A given computing device 802 may be configured for end-users, e.g., with applications, for administrators, as a server, as a distributed processing node, and/or in other ways.

Human users 812 may interact with the computer system comprising one or more computing devices 802 by using displays, keyboards, and other input/output devices 816, via typed text, touch, voice, movement, computer vision, gestures, and/or other forms of input/output. A screen may be a removable input/output device 816 or may be an integral part of the computing device 802. A user interface 811 may support interaction between an embodiment and one or more human users. A user interface 811 may include a command line interface, a graphical user interface (GUI), natural user interface (NUI), voice command interface, and/or other user interface (UI) presentations, which may be presented as distinct options or may be integrated.

System administrators, network administrators, software developers, engineers, and end-users are each a particular type of user 812. Automated agents, scripts, playback software, and the like acting on behalf of one or more people may also be users 812. Storage devices and/or networking devices may be considered peripheral equipment in some embodiments and part of a system comprising one or more computing devices 802 in other embodiments, depending on their detachability from the processor(s) 806. Other computer systems not shown in FIG. 8 may interact in technological ways with the computing device 802 or with another system embodiment using one or more connections to a network 814 via network interface 813 equipment, for example.

Each computing device 802 includes at least one logical processor 806. The computing device 802, like other suitable devices, also includes one or more computer-readable storage media including but not limited to memory 804 and data storage 808. The one or more computer-readable storage media may be of different physical types. The media may be volatile memory, non-volatile memory, fixed in place media, removable media, magnetic media, optical media, solid-state media, and/or of other types of physical durable storage media (as opposed to merely a propagated signal). In particular, a configured medium 818 such as a portable (i.e., external) hard drive, CD, DVD, memory stick, or other removable non-volatile memory medium may become functionally a technological part of the computer system when inserted or otherwise installed with respect to one or more computing devices 802, making its content accessible for interaction with and use by processor(s) 806. The removable configured medium 818 is an example of a computer-readable storage medium. Some other examples of computer-readable storage media include built-in RAM, ROM, hard disks, and other memory storage devices which are not readily removable by users 812.

The configured medium 818 is configured with binary instructions that are executable by a processor 806; “executable” is used in a broad sense herein to include machine code, interpretable code, bytecode, and/or code that runs on a virtual machine, for example. The configured medium 818 may also be configured with data which is created, modified, referenced, and/or otherwise used for technical effect by execution of the instructions. The instructions and the data configure the memory or other storage medium in which they reside; when that memory or other computer readable storage medium is a functional part of a given computing device, the instructions and data also configure that computing device.

Although an embodiment may be described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include other hardware logic components 810 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processor(s) 806 (e.g., CPUs, ALUs, FPUs, and/or GPUs), memory/storage media 804, 808, and screens/displays, an operating environment 800 may also include other hardware 810, such as batteries, buses, power supplies, wired and wireless network interface cards, for instance. The nouns “screen” and “display” are used interchangeably herein. A display may include one or more touch screens, screens responsive to input from a pen or tablet, or screens which operate solely for output. In some embodiment, other input/output devices 816 such as human user input/output devices (screen, keyboard, mouse, tablet, microphone, speaker, motion sensor, etc.) will be present in operable communication with one or more processors 806 and memory. Software processes may also be users 812.

In some embodiments, the system includes multiple computing devices 802 connected by network(s) 814. Network interface 813 equipment can provide access to network(s) 814, using components such as a packet-switched network interface card, a wireless transceiver, or a telephone network interface, for example, which may be present in a given computer system. However, an embodiment may also communicate technical data and/or technical instructions through direct memory access, removable non-volatile media, or other information storage-retrieval and/or transmission approaches.

The computing device 802 typically includes a variety of computer-readable media. Computer-readable media may be any available media that can be accessed by the computer and includes both volatile and nonvolatile media, and removable and non-removable media, but excludes propagated signals. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of the any of the above may also be included within the scope of computer-readable media. Computer-readable media may be embodied as a computer program product, such as software stored on non-transitory computer-readable storage media.

The data storage 808 or system memory includes computer storage media in the form of volatile and/or nonvolatile memory such as read only memory (ROM) and random access memory (RAM). A basic input/output system (BIOS), containing the basic routines that help to transfer information between elements within computer, such as during start-up, is typically stored in ROM. RAM typically contains data and/or program modules that are immediately accessible to and/or presently being operated on by processing unit. By way of example, and not limitation, data storage 808 holds an operating system, application programs, and other program modules and program data.

Data storage 808 may also include other removable/non-removable, volatile/nonvolatile computer storage media. By way of example only, data storage 808 may be a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. A user may enter commands and information through a user interface 811 or other input devices 816 such as a tablet, electronic digitizer, a microphone, keyboard, and/or pointing device, commonly referred to as mouse, trackball or touch pad. Other input devices 816 may include a joystick, game pad, satellite dish, scanner, or the like. Additionally, voice inputs, gesture inputs using hands or fingers, or other natural user interface (NUI) may also be used with the appropriate input devices 816, such as a microphone, camera, tablet, touch pad, glove, or other sensor. These and other input devices 816 are often connected to the processing units through a user input interface that is coupled to the system bus, but may be connected by other interface and bus structures, such as a parallel port, game port or a universal serial bus (USB). A monitor or other type of display device is also connected to the system bus via an interface, such as a video interface. The monitor may also be integrated with a touch-screen panel or the like. Note that the monitor and/or touch screen panel can be physically coupled to a housing in which the computing device is incorporated, such as in a tablet-type personal computer. In addition, computers such as the computing device may also include other peripheral output devices such as speakers and printer, which may be connected through an output peripheral interface or the like.

The computing device 802 may operate in a networked or cloud-computing environment using logical connections to one or more remote devices, such as a remote computer. The remote computer may be a personal computer, a server, a router, a network PC, a peer device or other common network node, and typically includes many or all of the elements described above relative to the computer. The logical connections may include one or more local area networks (LAN) and one or more wide area networks (WAN), but may also include other networks. Such networking environments are commonplace in offices, enterprise-wide computer networks, intranets, and the Internet.

When used in a networked or cloud-computing environment, the computing device 802 may be connected to a public or private network through a network interface or adapter. In some embodiments, a modem or other means may be used for establishing communications over the network. The modem, which may be internal or external, may be connected to the system bus via a network interface or other appropriate mechanism. A wireless networking component such as one comprising an interface and antenna may be coupled through a suitable device such as an access point or peer computer to a network. In a networked environment, program modules depicted relative to the computer, or portions thereof, may be stored in the remote memory storage device. It may be appreciated that the network connections shown are exemplary and other means of establishing a communications link between the computers may be used.

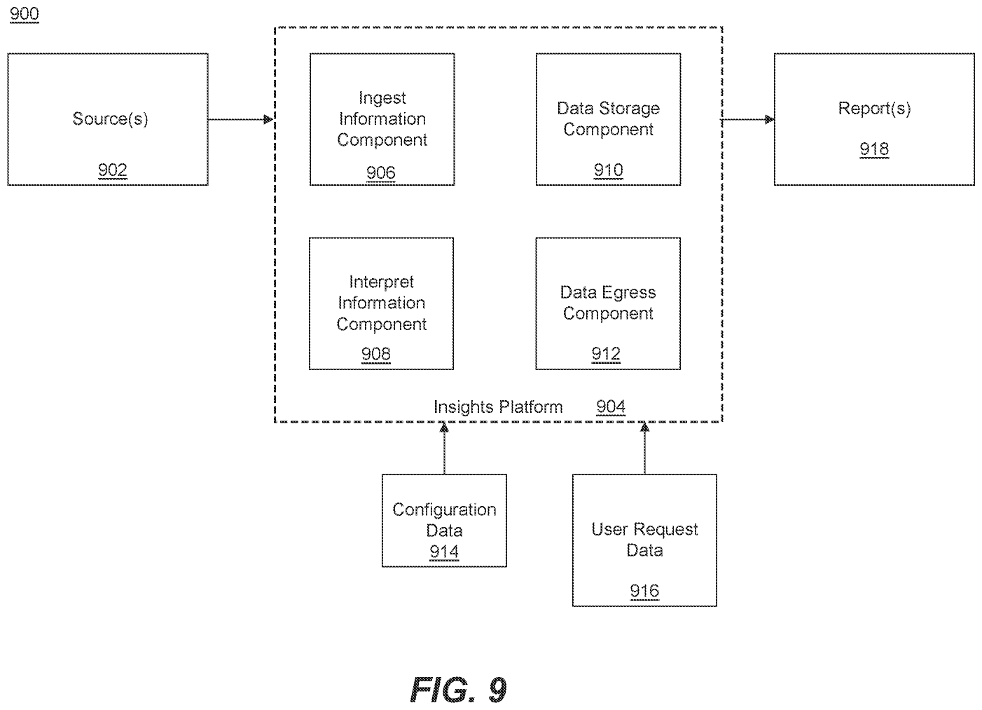

FIG. 9 is a block diagram showing an exemplary system for providing regulatory insights analysis, consistent with disclosed embodiments. As shown in FIG. 9, in some embodiments, the system 900 may include one or more sources 902 which provide input data in one or more formats or data types to an insights platform 904. An insights platform 904 may also receive other input including configuration data 914 and user request data 916. An insights platform 904 may further include various components including an ingest information component 906, an interpret information component 908, a data storage component 910, and a data egress component 912. In some embodiments, and based on a combination of input data including input data from source(s) 902, configuration data 914, and user request data 916, an insights platform 904 may provide output data 918 including results, reports, and insights.

In some embodiments, an ingest information component 906 of the insights platform 904 may be configured to receive input data from source(s) 902. An ingest information component 906 of the insights platform 904 may further be configured to normalize the received input data. It will be understood that the input data received from source(s) 902 may include data in various formats and/or data types which may be incompatible when combined or when processed by other components of the insights platform 904. As such, the insights platform 904 may be configured to normalize input data as it is received from source(s) 902. “Normalize,” as used herein, refers to the bringing or returning of data to a single or standard format. For example, raw data as entered into a general ledger or balance sheet may be normalized by an ingest information component 906 which processes each data entry and classifies it into one or more categories, each of which provides meaningful information which may be utilized to determine key drivers or factors of risk, loss, and/or revenue for, e.g., reporting purposes. See, e.g., FIGS. 5, 6, and the descriptions thereof.

In some embodiments, an interpret information component 908 of the insights platform 904 may be configured to analyze the normalized input data. For example, analyzing the normalized input data may include using functional logic for generating an output based on a first input including the normalized input data, a second input including calculation attributes, and a third input including one or more rules. “Calculation attributes,” as used herein, refer to persisted weights which are used to execute functional logic. As an example, calculation attributes may be generated and stored by the insights platform 904 based on, e.g., comparisons and/or correlations between the normalized input data. As another example, calculation attributes may be provided to the insights platform 904 via, e.g., configuration data 914 input via a user interface. “Rules,” as used herein, refer to instructions relevant to provide the context for executing functional logic. As an example, one or more rules may be provided to the insights platform 904 via, e.g., configuration data 914 input via a user interface. For example, a user may, via the user interface, upload a configuration file including one or more stored rules which may be edited or updated as needed. A configuration file may be in a standard format such as, e.g., XML or JSON, such that it may be easily read and interpreted by the platform 904 and stored in a rules repository. As another example, a user may directly enter one or more rules via the user interface or a command-line interface, which may allow for further customization of the one or more rules prior to its upload. As yet another example, one or more rules may be stored in an external database, such as a relational database or a NoSQL database, and the platform 904 may access and retrieve rules as needed or as configured based on additional user input via the user interface.

In some embodiments, the output of the interpret information component 908 may be stored in a data storage component 910 of the insights platform 904. Therefore, as input data continues to be received from source(s) 902, an insights platform 904 is configured, via components 906, 908, 910 to receive the input data, normalize the input data, analyze the input data to generate an output data, and store the output data.

Continuing the above example, and with further reference to FIG. 9, in some embodiments, a data egress component 912 of the insights platform 904 may be configured to continuously monitor the analyzed output as the output is stored. A data egress component 912 of the insights platform 904 may further be configured to generate one or more reports 918 based on the stored output or based on a further processing or analysis of the stored output.

In some embodiments, an insights platform 904 may further be configured to receive additional user input via a user interface. For example, an insights platform 904 may be configured to receive user request data 916 including at least one of additional input data, a request to view reports 918 generated by the insights platform 904, and/or a request for an additional output not included in the reports 918 generated by the insights platform 904.

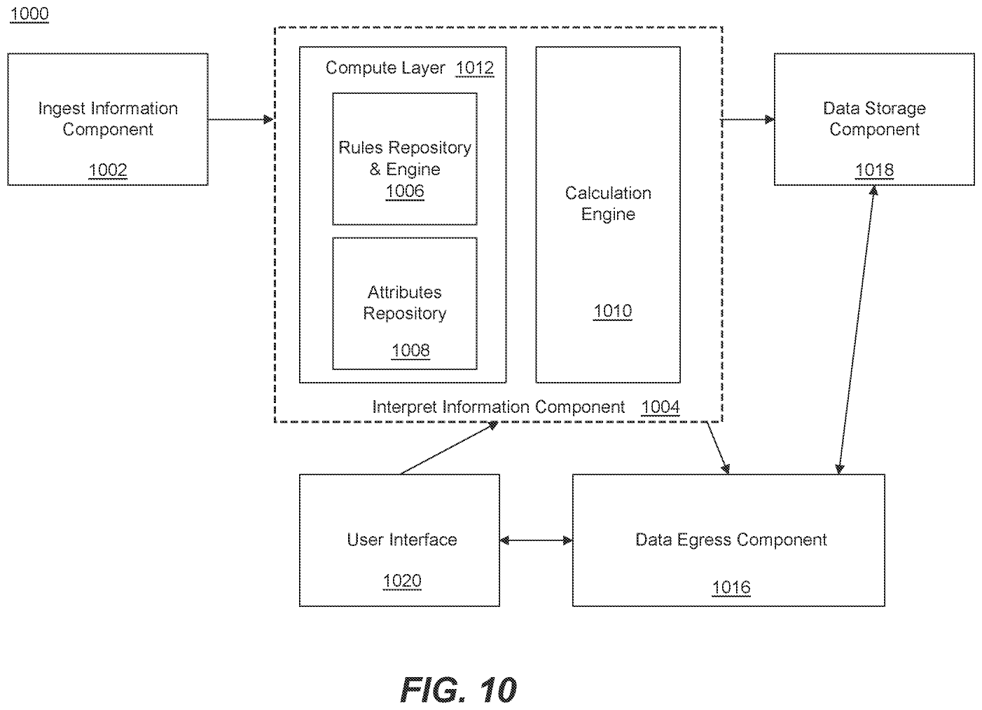

FIG. 10 is a block diagram showing a first detailed portion of an exemplary insights platform 1000 for providing regulatory insights analysis, consistent with disclosed embodiments. As shown in FIG. 10, an insights platform 1000 may include an ingest information component 1002, an interpret information component 1004, a data storage component 1018, and a data egress component 1016. In some embodiments, an ingest information component 1002 may be configured to receive input data from one source or a plurality of sources. An ingest information component 1002 may further be configured to normalize the input data and provide the normalized input data to an interpret information component 1004. In some embodiments, an interpret information component 1004 of the insights platform 1000 may include a compute layer 1012 and a calculation engine 1010. A compute layer 1012 of the interpret information component 1004 may include an attributes repository 1008 and a rules repository 1006. In some embodiments, a rules repository 1006 may also include a rules engine. Attributes repository 1008 may be configured, e.g., to store calculation attributes generated by or provided to an insights platform 1000, as described herein, which are relevant to provide weights for functional logic performed by the interpret information component 1004. Rules repository (and/or rules engine) 1006 may be configured, e.g., to store one or more rules (e.g., a set of rules) relevant to provide the context for functional logic performed by the interpret information component 1004. In some embodiments, a calculation engine 1010 of an interpret information component 1004 may be configured to perform the functional logic to generate an output based on a first input including the normalized data received from the ingest information component 1002, a second input including calculation attributes received from an attributes repository 1008, and a third input including one or more rules received from a rules repository (and/or rules engine) 1006.

In some embodiments, the output of the functional logic performed by the interpret information component may be provided to and stored in a data storage component 1018 of an insights platform 1000. A data storage component 1018 may include a results repository (not shown) which stores the output received from the interpret information component 1004. A data storage component 1018 may further include additional data persistence models which leverage data in the results repository to support further analysis. For example, a data storage component 1018 may include a data mart and/or a data lake (not shown), either of which may be built based on the stored output. “Data mart,” as used herein, refers to a subset of a data warehouse or data repository focused on a particular line of business, department, or subject area. “Data lake,” as used herein, refers to a centralized repository designed to store, process, and/or secure large amounts of structured, semi-structured, and/or unstructured data.

In some embodiments, an insights platform 1000 may also include a user interface 1020 configured to receive configuration data from a user and provide the configuration data to the interpret information component 1004. As an example, a user interface 1020 may be configured to receive configuration data including one or more rules input by a user and provide the one or more rules to a compute layer 1012 of an interpret information component 1004, wherein the configuration data is stored in a rules repository 1006 of the compute layer 1012, and wherein the one or more rules are provided from the rules repository 1006 to a calculation engine 1010 thereby providing a context for functional logic performed by the calculation engine 1010.

In some embodiments, a user interface 1020 may be configured to receive one or more requests from a user and provide data associated with the one or more requests to a data egress component 1016 of an insights platform 1000. For example, a user interface 1020 may be configured to receive one or more requests from a user to view one or more reports generated by the data egress component 1016 of the insights platform 1000. In response to such a request from a user, the data egress component 1016 may cause a display via the user interface 1020 on a client device of the user. As another example, a user interface 1020 may be configured to receive one or more requests from a user for an additional output not included in the reports typically generated by the insights platform 1000. An additional output requested may include, e.g., additional calculations requested by a user. An additional output requested may alternatively include, e.g., a request for data based on a combination or comparison of reports typically generated by the insights platform 1000.

In some embodiments, a data storage component 1018 and a data egress component 1016 of the insights platform 1000 may share information. For example, a data storage component 1018 may be configured to provide data from a results repository storing output from a interpret information component 1004 to a data egress component 1016. In turn, the data egress component 1016 may be configured to generate reports based on the received output data.

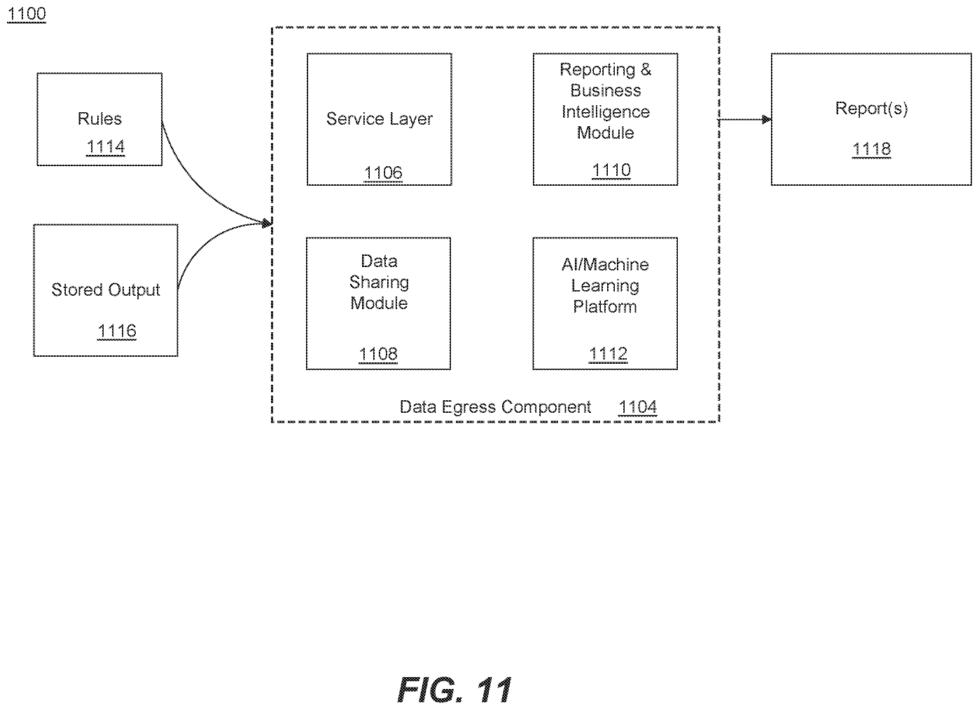

FIG. 11 is a block diagram showing a second detailed portion of an exemplary insights platform 1100 for providing regulatory insights analysis, consistent with disclosed embodiments. As shown in FIG. 11, in some embodiments, a data egress component 1104 of an insights platform 1100 may be configured to receive rules 1114 from a rules repository (and/or rules engine) of the insights platform 1100. For example, a service layer 1106 of the data egress component 1104 may be configured to receive rules 1114 in order to determine trigger values based on the received rules 1114. The data egress component may further be configured to receive stored output 1116 as the output is generated and stored by the insights platform 1100. As a result of receiving the stored output 1116, the data egress component may further be configured to continuously monitor the output data generated by calculations performed by the insights platform 1100 as the output data is stored. The determined trigger values may be used by the service layer 1106, while continuously monitoring the output of calculations performed by the insights platform 1100, to enable restful endpoints which perform one or more additional calculations or functions upon a detection of an output value which meets or exceeds a determined threshold value. The service layer 1106 may also be configured to be accessible to users and consumers via, e.g., one or more application programming interface (API) gateways. As a result, users and consumers may be enabled to request specific calculations or customized data, based on the output data stored in a results repository, directly from the service layer 1106.

In some embodiments, a data sharing module 1108 of a data egress component 1104 of an insights platform 1100 may be configured to receive stored output 1116 as generated by the insights platform 1100. In turn, a data sharing module 1108 may be configured to securely distribute reports 1118 which may include all or a set of output data generated by the insights platform 1100 to select and/or multiple client-side user devices or applications. Data sharing module 1108 may further distribute reports 1118 while maintaining data fidelity, confidentiality, integrity, and authenticity across all entities receiving the reports 1118.

In some embodiments, a reporting and business intelligence module 1110 of a data egress component 1104 of an insights platform 1100 may be configured to distribute reports, over one or more networks, to one or more particular businesses, institutions, or organizations. Reports may include, e.g., compliance risk assessment reports, financial condition reports, solvency analysis reports, consumer complaints reports, and risk management reports. A reporting and business intelligence module 1110 may further be configured to cause a display via a user interface, wherein the display may include reports, dashboards, and visualization tools. The displayed reports may be based on the output data stored in a results repository, one or more data marts, or a combination thereof. The dashboards and visualization tools may provide a user with summary information, interactive and customizable displays, a capability to request specific data to be displayed, and the like.

In some embodiments, an artificial intelligence (AI) and machine learning (ML) platform 1112 of a data egress component 1104 of an insights platform 1100 may be configured to provide machine learning insights via natural language processing, natural language generation, model development, training pipeline generation, and/or machine learning operations pipeline generation. An AI and ML platform 1112 may utilize supervised and/or unsupervised machine learning methods. For example, an artificial intelligence (AI) and machine learning (ML) platform 1112 may provide machine learning insights by transforming output data stored in a results repository of an insights platform 1100 into natural language (i.e., layman terms) which may be distributed to a user for consumption of the data in less complex or less technical terms. As another example, an artificial intelligence (AI) and machine learning (ML) platform 1112 may provide machine learning insights by developing a machine learning model based on a large amount of data stored in a data lake, the large amount of data being based on calculated output data. In turn, the machine learning model developed by the artificial intelligence (AI) and machine learning (ML) platform 1112 may provide insights including, e.g., trend predictions and future risk probabilities based on the input data received by the insights platform 1100. As yet another example, an AI and ML platform 1112 may provide machine learning insights by classifying raw data, embedding the classified data into vector representations, and thereby clustering the classified data to, e.g., determine and/or visualize relationships among the raw data.

The AI/ML platform 1112 may further be configured to perform any one of: supervised learning to perform linear regression or support vector analysis; unsupervised learning to perform clustering algorithms or principal component analysis; semi-supervised learning based on both labelled and unlabeled data; and deep learning to perform analysis using convolutional or recurrent neural networks. In addition, the AI/ML platform may be configured to perform any one of: rule-based AI to perform tasks or make decisions; decision tree AI to make decisions based on specific conditions; expert system AI to mimic decision-making by a human expert such as, e.g., a SME or data scientist; neural network AI to analyze data using interconnected nodes; NLP AI to analyze or generate text or human language; machine learning AI to perform analysis without explicit programming; and deep learning AI to perform analysis using multiple layers of neural networks.

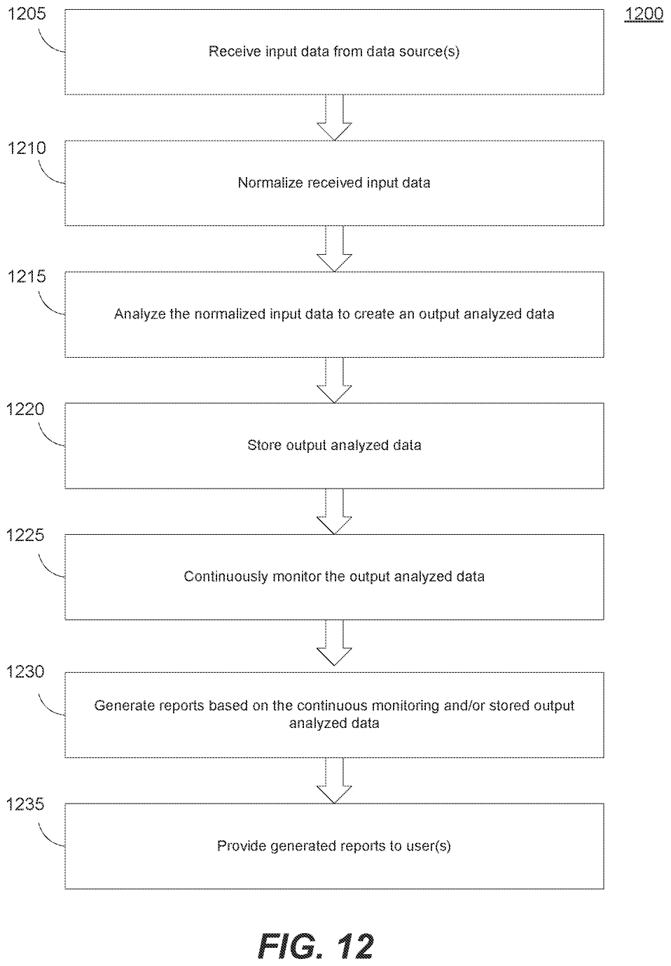

According to another embodiment of the present disclosure, a method for performing regulatory insight analysis may be provided. FIG. 12 is a flow chart showing an exemplary method 1200 for performing regulatory insights analysis, consistent with disclosed embodiments. As shown in FIG. 12, method 1200 may include a step 1205 of receiving input data from one or more data sources. Input data may represent regulatory compliance data related to an institution (e.g., a bank or insurance company). Input data may include, e.g., finance data, market risk data, liquidity risk data, credit risk data, actuarial risk data, banking risk data, insurance risk data, other risk data, loan data, data processing information, and third-party data. One of ordinary skill in the art will appreciate that input data can be received by suitable methods. For example, input data can be received by causing one or more processes to access, in a local or remote data store, a file containing the input data, or input data can be received from a user interface (e.g., a keyboard) and mapped to a memory address, or input data can be referenced as an address in memory, or input data can be received into a network interface and mapped to a memory address or stored as a file in a local data store, or input data can be retrieved from a cloud based storage, or input data may be retrieved from a local or remote database, or input data may be published as an event in an event streaming layer. In exemplary disclosed embodiments, an insights platform (or an ingest information component thereof) may receive input data as a batch file that is received when it is saved into a specifically configured folder or storage location within the insights platform.

Method 1200 may also include a step 1210 of normalizing the received input data. In some embodiments, a batch ingestion process may be performed for normalizing received input data. In an exemplary batch ingestion process, a scheduler may be configured to perform an “extract, transform, load” (ETL) process based on input data. An ETL process, as used herein, refers to a process to extract data from various sources, transform it into a format that can be used by various components of an insights platform, and then load it into the insights platform. The extract phase may involve extracting source data from various sources, such as databases, files, or other source systems. This source data may be in different formats and may need to be cleaned and structured before it can be used. The transform phase may involve transforming the data into a format that is suitable for the insights platform. This may include converting data types, aggregating data, performing calculations on the data, and normalizing the data. See, e.g., FIGS. 5, 6, and the descriptions thereof. The load phase may involve loading the transformed data into a database or data warehouse of the insights platform. The data may be loaded in a batch process, wherein data from multiple sources may be combined and loaded into the insights platform at once.

In some embodiments, the input data processed by a scheduler may be stored as normalized data in a transient data storage (i.e., a landing zone) prior to being further analyzed. In other embodiments, a streaming process may be performed for receiving input data, wherein one or more sources provide input data, e.g., as topics, and wherein the input data is normalized in real time.

Further, method 1200 may include a step 1215 of analyzing the normalized input data to create an output analyzed data. The analyzing may be performed, e.g., by an interpret information component of an insights platform, as described herein. Furthermore, the analyzing may be performed by a calculation engine performing functional logic based on the normalized input data, one or more calculation attributes, and one or more rules, as described herein. As an example, analyzing the normalized input data may include calculating a mean, median, or mode of a set of normalized data, finding a standard deviation of normalized data, determining minimum and maximum values in a normalized dataset, determining a correlation between two or more sets of normalized data, identifying outliers or anomalies in a set of normalized data, calculating a slope of a trend line for normalized data, identifying trends or patterns in data over time, generating histograms or scatterplots to visualize normalized data, performing regression analysis to predict future values, generating confidence intervals for statistical estimates based on normalized data, and/or conducting hypothesis testing to determine statistical significant of normalized data trends.

Method 1200 may further include a step 1220 of storing the output data. The output data may be stored, e.g., in a data storage of an insights platform, as described herein. Furthermore, a data storage of an insights platform may include a results repository, one or more data marts, and a data lake, as described herein.

Method 1200 may include a step 1225 of continuously monitoring the output analyzed data as it is stored by an insights platform. By continuously monitoring the data, the platform may be enables to perform additional functions based on a continuously changing output. Alternatively, or in addition, if input data is incorrectly sourced, the platform may be capable of detecting such errors in data input. Additional benefits of continuous monitoring may include, e.g., improved efficiency, increased security, improved decision-making, and enhanced compliance. In some embodiments, the continuous monitoring may be performed by a service layer of a data egress component of an insights platform, as described herein. For example, an insights platform may determine threshold values based on one or more rules and trigger restful endpoints to perform additional functions or calculations upon detecting a monitored output data value that meets or exceeds a determined threshold value.

Method 1200 may further include a step 1230 of generating one or more reports based on the continuous monitoring and/or based on stored output data. For example, a data egress component of an insights platform may generate business intelligence data and/or machine learning insights, as described herein.

Further, method 1200 may include a step 1235 of providing the generated reports to one or more users. Users may include consumers, regulators, businesses, or any other entity which may have interest in receiving regulatory insight data. As an example, a data egress component of an insights platform may distribute regulatory insight reports to a set of entities via, e.g., a data sharing module, as described herein. As another example, a data egress component of an insights platform may cause a display of reports and additional visualizations to a particular business or organization via a reporting and business intelligence module, as described herein. As yet another example, a data egress component of an insights platform may distribute machine learning insights to a user via, e.g., a AI/ML platform, as described herein.

Method 1200 may also include a step (not shown) of receiving additional input from a user via a user interface. Additional input from a user may include, e.g., an additional input data (e.g., configuration data, calculation data, rule data, etc.), a request to view a particular report generated by the insights platform, and/or a request for an additional output not generated automatically by the insights platform.

Method 1200 may be driven via an orchestration layer. As used herein, orchestration may refer to one or more of automated configuration, coordination, and management of a computer system, systems, or software. As used herein, configuration may refer to the arrangement of hardware and/or software of a computer system or network. As used herein, coordination may refer to a programming language coordinating instruction, an operating system coordinating access to hardware, a database transaction schedule coordinating access to data, or any other similar process involving coordination. As used herein, management may refer to a process of managing, monitoring, maintaining, or optimizing a computer system for performance, availability, security, and/or any base operational requirement.

It will be apparent to those skilled in the art that various modifications and variations can be made for the integration of a software component into a software framework, the software framework, or the orchestration and integration of data, as executed by at least one processor. While illustrative embodiments have been described herein, the scope of the present disclosure includes any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the

What is claimed is:

1. A system for providing regulatory insight analysis, comprising:
a memory,
at least one data storage medium, and
at least one processor configured to:
receive input data from a plurality of sources;
normalize the received input data;
analyze the normalized input data, the analyzing comprising using logic for generating an output based on a first input including the normalized input data, a second input including calculation attributes, and a third input including one or more rules;
store the output;
continuously monitor the output as the output is stored;
generate one or more reports based on the stored output; and
receive, from a user and via a user interface:
additional input data;
a request to view the one or more generated reports; or
a request for an additional output.

2. The system of claim 1, wherein the at least one processor is further configured to store the normalized input data in a transient data storage prior to analyzing the normalized input data.

3. The system of claim 1, wherein the at least one processor is further configured to:
generate the calculation attributes based on the normalized input data from at least one of the plurality of sources; and
store the calculation attributes.

4. The system of claim 1, wherein the at least one processor is further configured to:
receive the one or more rules as configured by the user via the user interface; and
store the one or more rules.

5. The system of claim 1, wherein the at least one processor is further configured to leverage the stored output to build at least one of a data mart or a data lake.

6. The system of claim 1, wherein the at least one processor is further configured to:
monitor a value received based on the continuously monitored output;
determine a threshold value based on the one or more rules; and
trigger a restful endpoint upon receiving a monitored value meeting or exceeding the determined threshold value, wherein triggering the restful endpoint provides at least one additional function based on the received monitored value.

7. The system of claim 1, wherein the at least one processor is further configured to securely distribute the stored output to multiple client-side devices.

8. The system of claim 1, wherein the at least one processor is further configured to provide, via the user interface, insights based on the stored output using at least one of a model or a pipeline generated via a machine learning platform.

9. A method for providing regulatory insight analysis, the method comprising:
receiving input data from a plurality of sources;
normalizing the received input data;
analyzing the normalized input data, the analyzing comprising using logic for generating an output based on a first input including the normalized input data, a second input including calculation attributes, and a third input including one or more rules;
storing the output;
continuously monitoring the output as the output is stored;
generating one or more reports based on the stored output; and
receiving, from a user and via a user interface:
additional input data;
a request to view the one or more generated reports; or
a request for an additional output.

10. The method of claim 9, further comprising storing the normalized input data in a transient data storage prior to analyzing the normalized input data.

11. The method of claim 9, further comprising:
generating the calculation attributes based on the normalized input data from at least one of the plurality of sources; and
storing the calculation attributes.

12. The method of claim 9, further comprising:
receiving the one or more rules as configured by the user via the user interface; and
storing the one or more rules.

13. The method of claim 9, further comprising leveraging the stored output to build at least one of a data mart or a data lake.

14. The method of claim 9, further comprising:
monitoring a value received based on the continuously monitored output;
determining a threshold value based on the one or more rules; and
triggering a restful endpoint upon receiving a monitored value meeting or exceeding the determined threshold value, wherein triggering the restful endpoint provides at least one additional function based on the received monitored value.

15. The method of claim 9, further comprising securely distributing the stored output to multiple client-side devices.

16. The method of claim 9, further comprising providing, via the user interface, insights based on the stored output using at least one of a model or a pipeline generated via a machine learning platform.

17. A non-transitory computer readable medium containing instructions that when executed by at least one processor, cause the at least one processor to perform operations for providing regulatory insight analysis, the operations comprising:
receiving input data from a plurality of sources;
normalizing the received input data;
analyzing the normalized input data, the analyzing comprising using logic for generating an output based on a first input including the normalized input data, a second input including calculation attributes, and a third input including one or more rules;
storing the output;
continuously monitoring the output as the output is stored;
generating one or more reports based on the stored output; and
receiving, from a user and via a user interface:
additional input data;
a request to view the one or more generated reports; or
a request for an additional output.

18. The medium of claim 17, wherein the operations further comprise providing, via the user interface, insights based on the stored output using at least one of a model or a pipeline, the at least one of a model or a pipeline being generated via a machine learning platform.

19. The medium of claim 17, the operations further comprising storing the normalized input data in a transient data storage prior to analyzing the normalized input data.

20. The medium of claim 17, the operations further comprising:
monitoring a value received based on the continuously monitored output;
determining a threshold value based on the one or more rules; and
triggering a restful endpoint upon receiving a monitored value meeting or exceeding the determined threshold value, wherein triggering the restful endpoint provides at least one additional function based on the received monitored value.
